(19) United States
(12) Patent Application Publication
(10) Pub. No.: US 2008/0017174 A1
(43) Pub. Date: Jan. 24, 2008

(54) Electronic Control Unit for Motor Vehicle Braking Systems

(75) Inventors: Wolfgang Kafer, Frankfurt (DE); Michael Jurgens, Wolfersheim (DE); Jurgen Peter Gilb, Wehrheim (DE); Ralf Weyrich, Weinsheim (DE); Matthias Viering, Darmstadt (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/583,067

(22) PCT Filed: Dec. 15, 2004
(86) PCT No.: PCT/EP04/53476

§ 371 Date: Jul. 16, 2007

(30) Foreign Application Priority Data
Dec. 17, 2003 (DE) 10359477.9
Sep. 13, 2004 (DE) 102004044600.8

(51) Int. Cl. B60T 8/62

(52) U.S. Cl. 123/479; 701/70

(57) ABSTRACT

Disclosed is an electronic control unit (14) connected to a hydraulic unit (13), such as in a motor vehicle, by way of a magnetic plug. The electronic control unit includes a zone formed of housing walls (14′) for accommodating several valve coils (12) arranged in the zone. Also included are a housing cover (8, 35) and at least one printed circuit board (31, 5) that accommodates electric and/or electronic components. Also included are an electrical contact and a heat-conducting plate (9, 32) for dissipating heat from the electronic components. The heat-conducting plate is connected to the printed circuit board. At least one thermal connecting element (4, 15) is provided, which constitutes a thermal bridge between the printed circuit board(s) and the heat-conducting plate(s).

### BACKGROUND OF THE INVENTION

The invention relates to an electronic control unit for connection to a hydraulic unit (13) by way of a magnetic plug, in motor vehicle brake systems; a pump driving unit for an electronic control unit, which is connected to a hydraulic unit (HCU), having an electric motor driving a driving axle; and a method of manufacturing an electronic control unit; and an electrohydraulic control device comprising a mounting frame for electric valve coils (12) which is in particular substantially made of plastics, a strip conductor carrier with at least one semiconductor element producing thermal energy and at least one planar cooling element (9), especially a cooling plate, a hydraulic block connected to the mounting frame and having valve domes of magnetically drivable hydraulic valves that project from a surface of the hydraulic block, the hydraulic valves being arranged inside the hydraulic block.

EP 0 520 047 B1 (P 7129) discloses an ABS control device which is designed according to the principle of a so-called ‘magnetic plug’ equipped with movable, elastically held valve coils in an electronic housing. The electronic unit (ECU) provided with integrated printed circuit board and the valve coils is connected in a plug-type manner to a valve block (HCU) which comprises the valve domes and additional hydraulic components of the brake assembly. The ECU further comprises an integrated plug for connection of a connecting cable (e.g. wheel sensor cable). Control devices according to this principle have become generally accepted in the automotive industry and are therefore frequently employed for manifold control tasks (e.g. ABS, ESP, etc.) in motor vehicle brake systems.

As can be taken from DE 197 43 842 A1 (P 9117), it is also known in the art to use cooling plates made of aluminum in ABS control devices to cool the electronic components, said cooling plates being connected planarly with the carrier plates which carry the electronic components and the strip conductors. The housing of the controller, which is made of plastics in many cases, very frequently is used as a mounting frame for the valve coils and for accommodating the electronic components including the cooling plate. In some cases, the cover of the controller housing is made of a material having a high degree of thermal conductivity, and the cooling plates have already been brought into thermal contact with said cover by way of corresponding heat conducting elements.

Finally, DE 100 11 807 A1 (P 9817) discloses a control device for a ‘brake-by-wire’ brake system aiming at an electrohydraulic brake (EHB). This publication represents already a controller housing with an aluminum cover provided with ribs or knobs to improve cooling of the incorporated electronic components, and the aluminum cover is connected to the controller housing by way of a circumferential seal. Because of the great number of difficult-to-manufacture metal parts, the construction described is not yet optimized to an appropriate extent for large-scale manufacture.

Another example for an up-to-date controller connected to a valve block and provided for a driving dynamics control unit, well suited for ABS and ESP, according to the state of the art is described in detail hereinbelow making reference to FIGS. 20 and 21. Likewise this construction does not yet satisfy the demands placed on a modern electrohydraulic control device for motor vehicle brake systems to an appropriate degree.

An object of the invention is to maintain the functional reliability of an electrohydraulic control device of the above-mentioned type while designing it with still reduced structural and functional means, and another objective is to realize especially good conditions for dissipating the heat produced by the electronic components.

### SUMMARY OF THE INVENTION

This object is achieved by a novel electronic control unit for the connection to a hydraulic unit by way of a magnetic plug, in particular in motor vehicle brake systems.

The so-called controller housing of the invention primarily serves to accommodate electronic control assemblies. The controller housing can be connected in a per se known fashion to a hydraulic unit by way of electric and hydraulic interfaces to become an electrohydraulic control device. The coils for the hydraulic valves are arranged in the controller housing according to the per se known principle of the magnetic plug. When the controller and the valve block are joined, the coils are slipped over the domes of the hydraulic valves that project from the block. The electrohydraulic control device described is preferably inserted into electronic motor vehicle brake systems, in particular with ESP functions.

According to the invention, novel electronic additional functions can be integrated into an electronic control unit in a favorable manner. As this occurs, the usual electromechanical demands placed on a control device for a motor vehicle brake system such as mechanical robustness, reliability of operation, endurance, electrical reliability of operation, thermal reliability of operation, optimal utilization of the mounting space, low effort in manufacture, etc., are further satisfied partly to a sufficient degree, or they are even more than satisfied in some points.

The control unit is well suited for the usual electronic regulating and controlling tasks, such as anti-lock system (ABS), yaw rate control or electronic stability program (ESP, TCS), etc. The control unit is particularly appropriate for use in modern electric brake systems with high requirements.

The electronic integrated motor vehicle brake control device consists of the elements of electronic controller housing (ECU), hydraulic block with hydraulic valves (HCU), and pump drive (PA).

The electronic control unit according to the invention, among others, has the advantage that there is no need for sophisticated, previously necessary liquid seals.

Further, the invention is favorable in that the ECU manages without a previously conventional intermediate bottom in the housing, as it has formerly been used as an abutment for the printed circuit board. This provides mounting space for a second printed circuit board, which is arranged in the direction of the coils and has not existed so far in controller housings known in the art. As a result, electrical connections of the magnet coils and particularly of the pressure sensors can be combined. Besides, the use of a second printed circuit board provides greater space that can serve for cooling purposes.

The possibility of electrically connecting the coils to the second printed circuit board achieves an increased degree in

flexibility when arranging the coils. Besides, additional space is provided for the components on the first printed circuit board.

The invention further relates to a new pump-driving unit which, compared to prior art solutions, is favorable in that the electronic power components for driving the motor are mounted on a motor base plate, whereby favorable cooling is permitted.

Another objective of the invention is to improve the heat dissipation from the cooling plate to the environment still further.

This object is achieved among others by the electrohydraulic control device.

The control device of the invention according has a number of advantages as compared to the solutions of the state of the art. The constantly growing scope in functions of the electronics and a still further increasing integration density makes the dissipation of the lost heat of the circuitry even more significant. The inventive thermal connection of a planar cooling element (e.g. due to the metal members embedded in the housing) to the hydraulic block allows linking the cooling element and, thus, also the sensitive electronic semiconductor components to a heat reservoir of good heat-conductivity with a high specific heat by using a direct metallic connection, with the result that the necessary cooling of the electronic components is significantly improved by a low thermal resistance. The great heat capacity of the valve block can be favorably used for cooling according to the disclosed concept.

Due to the massive attachment of the cooling plate used for cooling the printed circuit board to the metal members embedded in the housing, e.g. by way of screws or by wedging operation, the risk is reduced that the printed circuit board may e.g. shift in its press-in contacts, or even get detached therefrom. This optimized suspension of the printed circuit board additionally renders it possible that additional printed circuit boards for the integration of e.g. sensor systems can be fitted on the main board without the additional mass being critical for the suspension of the printed circuit boards.

Preferably, the metal members employed may be designed as sleeves so that the controller with the hydraulics can be connected also to the hydraulic block at these inward positions by way of corresponding screws that extend through the sleeves. The previous outward attachment sleeves are no longer needed in this case.

Further, a construction with yoke rings and without additional plastic arms or with resilient pressed screens allows favorably realizing a particularly simple coil suspension without spray-coating or additional fastening elements.

Additional preferred embodiments become apparent from the sub claims and the following description of the Figures.

The invention is described in more detail hereinbelow with reference to examples.

### BRIEF DESCRIPTION OF THE DRAWINGS

In the drawings:

FIG. 1 shows the mechanic construction of an electronic controller;

FIG. 2 is a cross-sectional view of a control device housing for an ESP brake system;

FIG. 3 is a cross-sectional view in the area of the valve block sealing between housings of the ECU and the HCU;

FIG. 4 shows a pump-driving unit with integrated power electronics;

FIG. 5 is another illustration of the pump-driving unit, which shows the particularly integrated electronic components with the power drivers;

FIG. 6 shows a cross-section taken through an electronic controller (ECU) with a double heat-conducting plate;

FIG. 7 shows an enlarged view of an ECU with a metal cover;

FIG. 8 depicts an ECU with two printed circuit boards laminated onto a cooling member;

FIG. 9 is another illustration of an ECU housing including printed circuit board, heat-conducting plate, and novel coil connection;

FIG. 10 is another illustration of an ECU housing with an alternative cooling in the cover;

FIG. 11 is another illustration of an ECU housing with a heat-conducting cushion;

FIG. 12 shows an example of an ECU with an improved heat coupling between the heat-conducting plate and the strip-conductor carrier plate;

FIG. 13 is a top view of a heat-conducting plate;

FIG. 14 shows the connection of the ECU cover to the ECU housing;

FIG. 15 shows another suggestion for an improved heat coupling between the heat-conducting plate and the printed circuit board carrier plate;

FIG. 16 shows a possible assembly for an additional printed circuit board;

FIG. 17 is a schematic cross-sectional view of a brake control assembly with continuous cylindrical metal cooling members;

FIG. 18 shows another example for the attachment of the metal cooling members similar to FIG. 17;

FIG. 19 shows another example based on the concept in FIG. 17 with heat-conducting screws;

FIG. 20 shows a controller housing according to the state of the art with a cooling plate, and

FIG. 21 shows another controller housing according to the state of the art including a spring steel sheet.

### DETAILED DESCRIPTION OF THE DRAWINGS

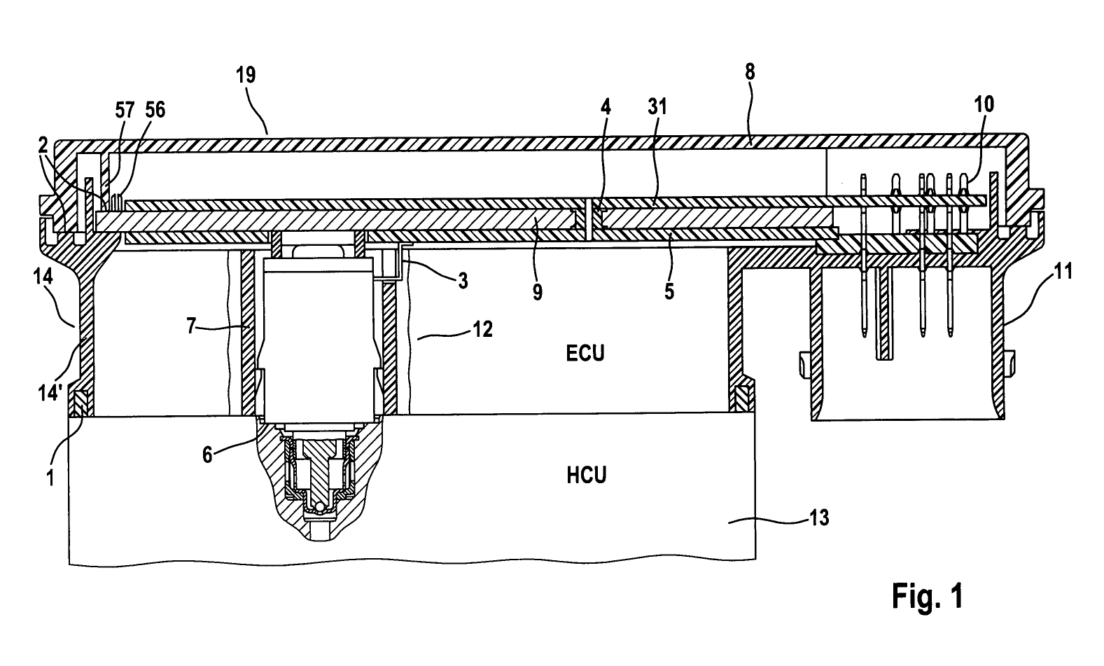

FIG. 1 shows an ECU 14 fitted to HCU 13. An assembly made up of printed circuit board 31, with precisely one heat-conducting plate 9 made of aluminum, and another printed circuit board 3 is inserted into the controller housing 14 of the ECU. Housing 14 is sealed relative to the HCU in the area of the housing wall 14′ by means of a circumferential seal 1. Seal 1 is preferably made of hose material and inserted into a housing groove. In the assembly of printed circuit boards 31 and 3 as well as heat-conducting plate 9, the cylindrical heat-conducting member 4 (only on heat-conducting member is illustrated in the example for the sake of clarity) not only represents a heat-conducting bridge, but additionally an electric contact is established between the two printed circuit boards 31 and 3. Heat-conducting member 4 favorably is composed of the same material as the heat-conducting plate 9. This provides the advantage that different heat expansion coefficients of plate 9 and heat-conducting member 4 will not cause excessive mechanical stress until destruction of the printed circuit board assembly. Preferably, the heat-conducting member 4 is embedded into plastic material, in particular injection-molded. For the electrical contacting of the valve coils 12, their coil wires 3 are connected with the printed circuit board 3 by means of soldering with the aid of a punch. Like on printed circuit board 31, additional electronic components can further be arranged on the other printed circuit board 3 in a favorable manner. In the example shown, the illustrated coils 12 are immersed into a cavity in the surface of the HCU when ECU and HCU are joined. To this end, coil 12 has a C-shaped yoke 6, which is in thermal contact with HCU 13. These conditions allow considerably reducing the necessary mounting space (overall height) of the control device.

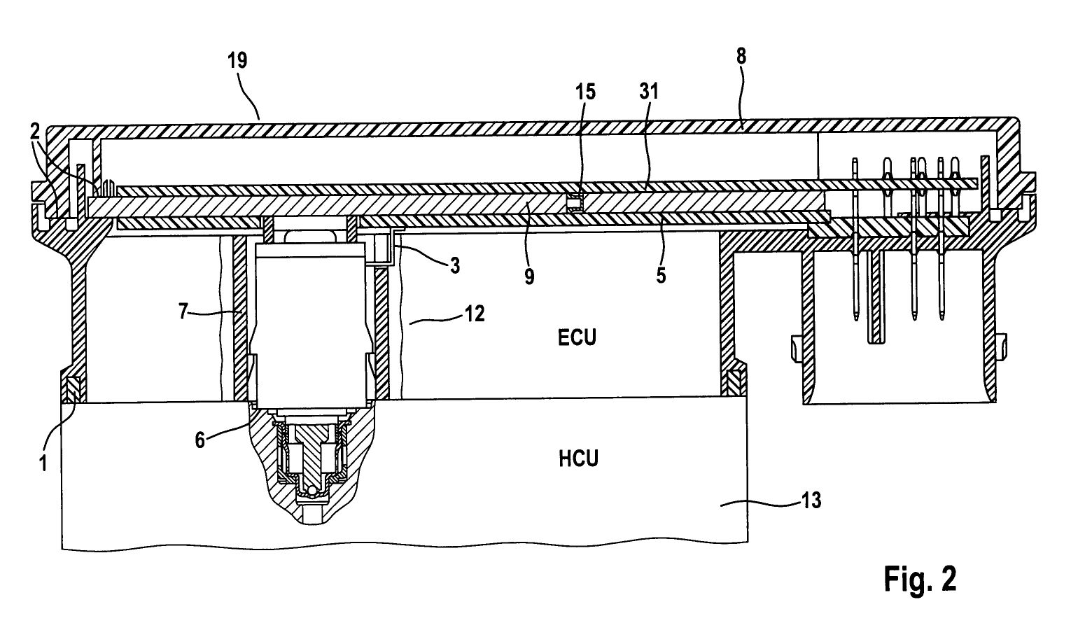

In FIG. 2, an expandable, resilient heat-conducting element 15, suitably similar to a copper spring, is used instead of an aluminum heat-conducting member 4 in order to establish a thermal contact within the printed circuit board assembly of FIG. 1.

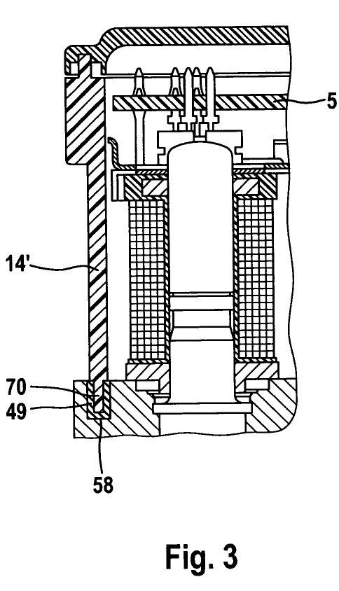

FIG. 3 illustrates a circumferential sealing groove 58 at the edge of the HCU, which is machined as a recess into the surface of the HCU being connected to the ECU. Engaging groove 58 is a clamping tongue 70 of the ECU cover, which is sealed by filling groove 58 with a suitable cementing and/or sealing means 49. This construction is advantageous because it not only seals but also has a high degree of holding force so that an additional attachment of the cover becomes unnecessary.

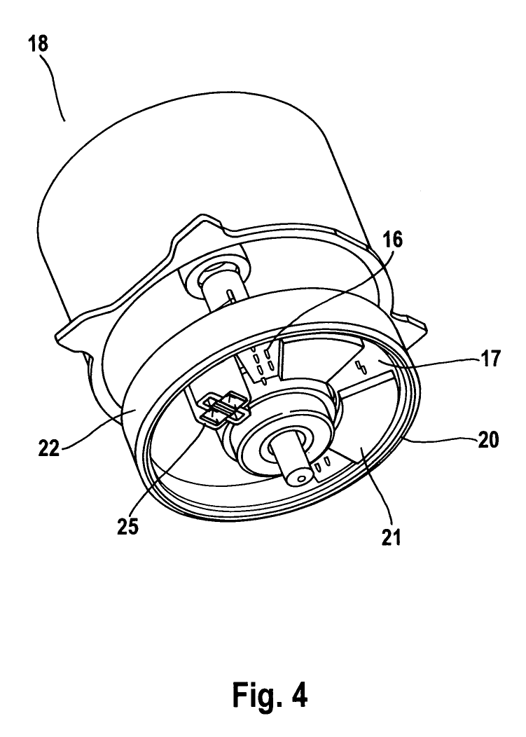

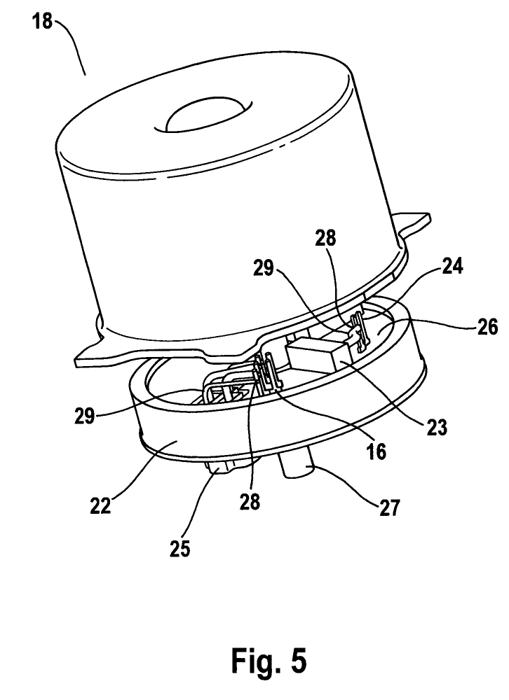

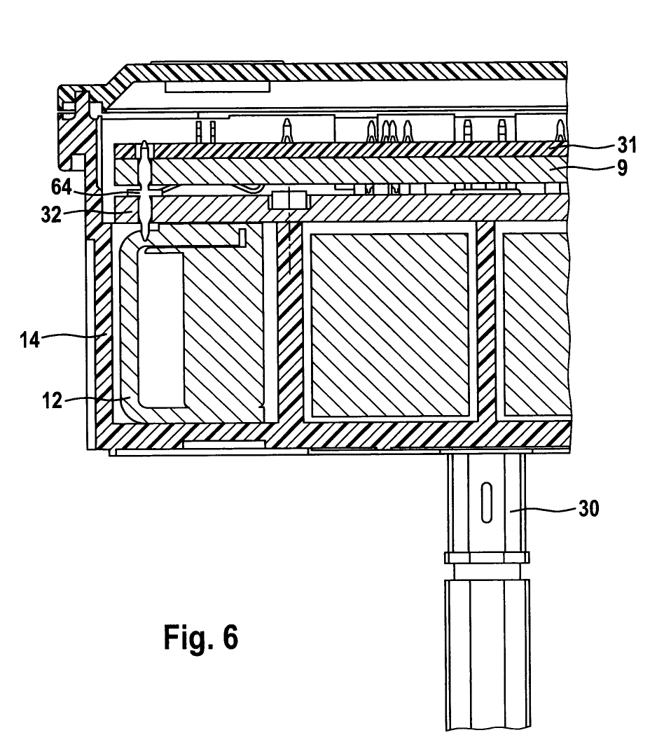

FIGS. 4 and 5 show a pump-driving unit 18 with a motor base plate 22 made of plastics. Press-in contacts 16 are injection-molded in plate 22. Further, a printed circuit board 26 is inserted into said plate for the accommodation of the electronics. Besides, plate 22 comprises plastic retainers (not shown), e.g. made of PPA, by means of which brushes 23 are fastened to base plate 22. Special contacts can be shaped in the retainers already. The electronics of the pump-driving unit is connected to the ECU by way of a per se known duct (reference numeral 30 in FIG. 6), said duct extending through the HCU. The duct has the shape of an elongated rod with a male electric plug engaging in bushing 25 when mounted, which latter is connected to plate 22. ECU likewise includes a plug for the contact with the elongated rod. On the side of printed circuit board 18 close to the valve block, there are tolerance-compensating heat-conducting elements 21 made of a soft elastic material which are in thermal contact with power components of the motor.

By way of heat-conducting plates 21, which abut on large surfaces of the valve block 13, the heat of the power components of the motor is dissipated in a particularly effective manner to the metal member of the valve block 13 according to the principle of a ‘heat sink’.

FIG. 6 shows another alternative of the connection of printed circuit board 31 to heat-conducting plates I 9 and II 32, where there is no direct thermal contact between plates 9 and 32. Attached mechanically to the second heat-conducting plate 32 are valve coils 12 without the use of spring steel sheets. Heat-conducting plate 32 is screwed to housing 14. Reference numeral 64 refers to a double press-in contact, which is used for electrically coupling the top printed circuit board 31 to a valve coil or for thermally contacting the heat-conducting plates 9 and 32. Double press-in contacts 64 will then also provide a thermal contact between the two heat-conducting plates.

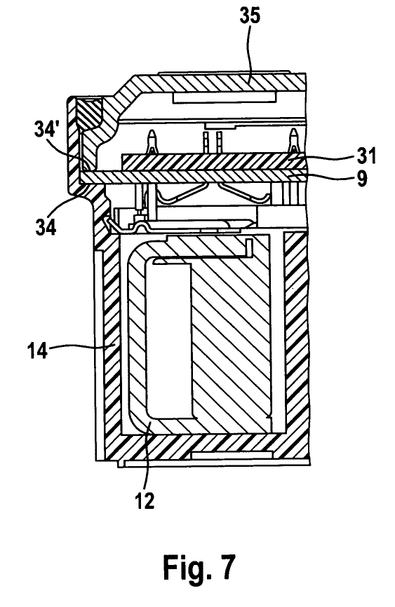

The ECU housing 14 illustrated in FIG. 7 includes a cover 35 made of a metal such as aluminum. Cover 35 is cemented to housing 14. Heat-conducting plate 9 bears against an abutment surface 34 shaped in controller housing 14 in this example. Above this abutment surface, on the opposite side of plate 9, metal cover 35 abuts partially on abutment surface 34′ so that cover 35 retains plate 9. The connection between the heat-conducting plate 9 and the metal cover 35 provides particularly good heat dissipation relative to the ambience.

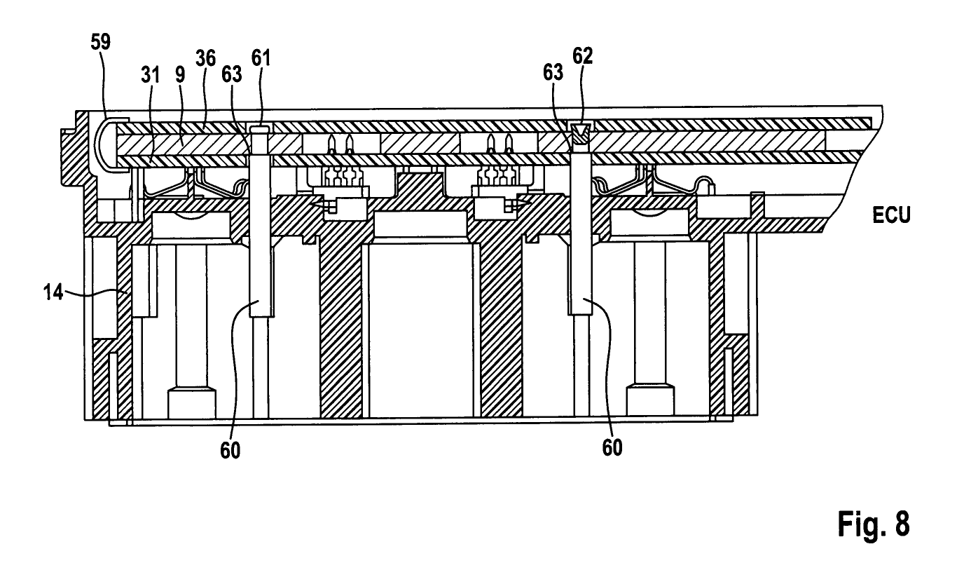

FIG. 8 shows a variation of an ECU wherein the additional board 36 is laminated on the opposed second surface of the heat-conducting plate 9—also like main board 31—, and the additional board is connected electrically to the main board 31 by way of a flexible foil 59. Foil 59 can be connected to the printed circuit board(s) by soldering with the aid of a punch, or it is made in a lamination process jointly with the printed circuit board. Elements 31, 9, and 36 represent a board subassembly attached to controller housing 14 by means of metal pins 60. The board subassembly is fastened to metal pins 60 by means of a rivet connection 61 or a wedged connection 62, and corresponding tapered portions of the pins 60 engage in suitably positioned recesses of the subassembly. For simplified manufacture, metal pins 60 are injection-molded in predefined positions in the plastics controller housing 14 while said is manufactured. When the tapered portions of the pins 60 are appropriately dimensioned, abutment surfaces 63 lying on one level are achieved, which represent a particularly favorable possibility of vertically positioning the board subassembly.

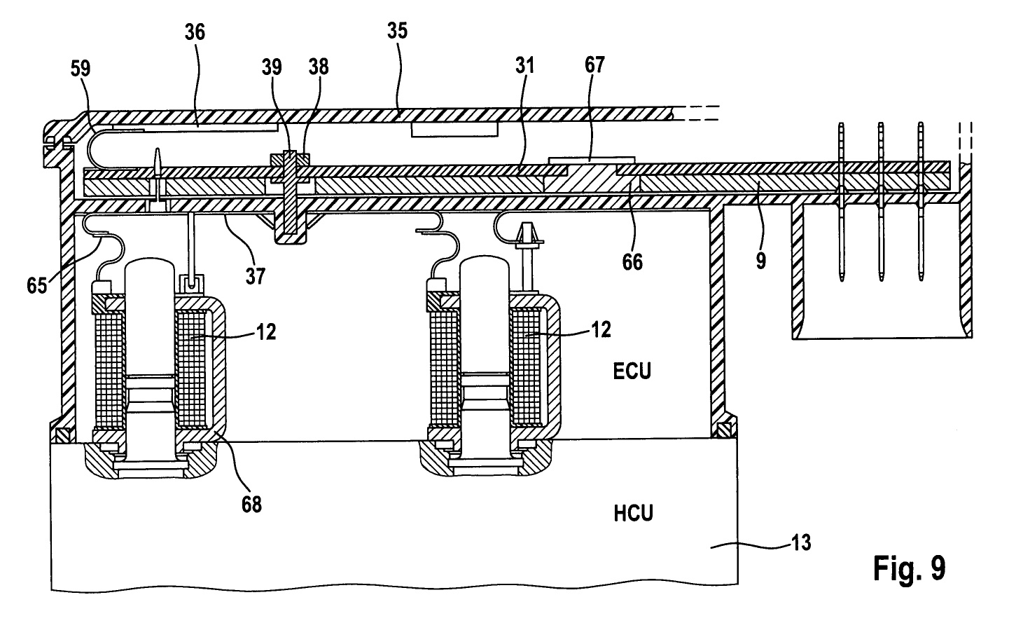

The additional board 36 is attached to cover 35 in FIG. 9. A flexible connection to the main board 31 occurs by way of flexible foil 59. The additional board 36 can provide electronic subassemblies for additional functions such as TPMS, DDS, or other functions. For attaching the valve coils 12, a pressed screen 37 is provided, to which initially the coil contacts 65 can be welded during manufacture, which have a resilient design. After the coil attachment, pressed screen 37 is inserted into the ECU housing, being retained by way of spring steel sheets seized as if with claws. Nut or rivet 38 connects the printed-board assembly thermally to heat-conducting plate 9 by way of bolts 39. Bolt 39 is made of copper or any suitable copper/tin alloy for reasons of a coefficient of thermal expansion, which is adapted as much as possible. Reference numeral 66 designates a copper pin which is press fitted in heat-conducting plate 9. This pin is in thermal contact with electronic component 67. The disclosed coil contacting and attachment by means of a resilient suspension 67 achieves improved dissipation of the heat developing in the coils. In this connection, also the illustrated direct contact of the coil yoke 68 to the valve block is advantageous.

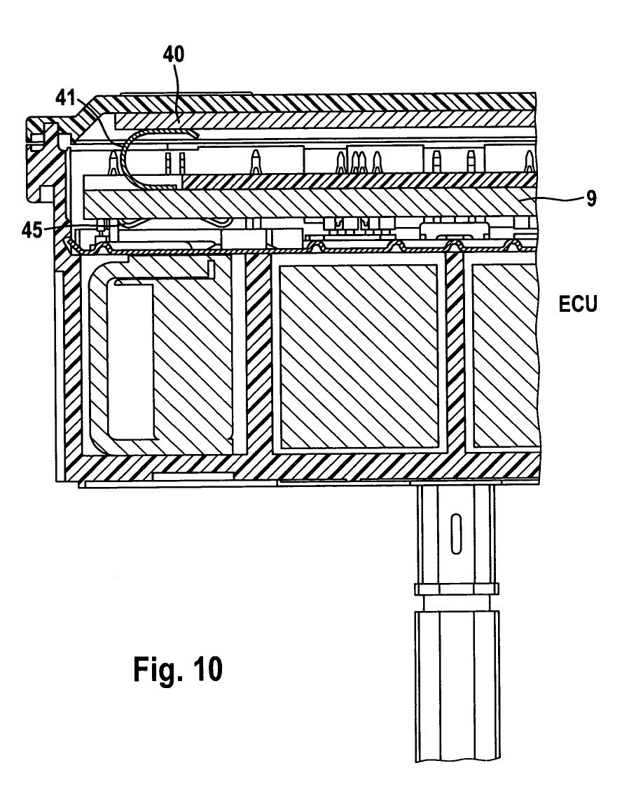

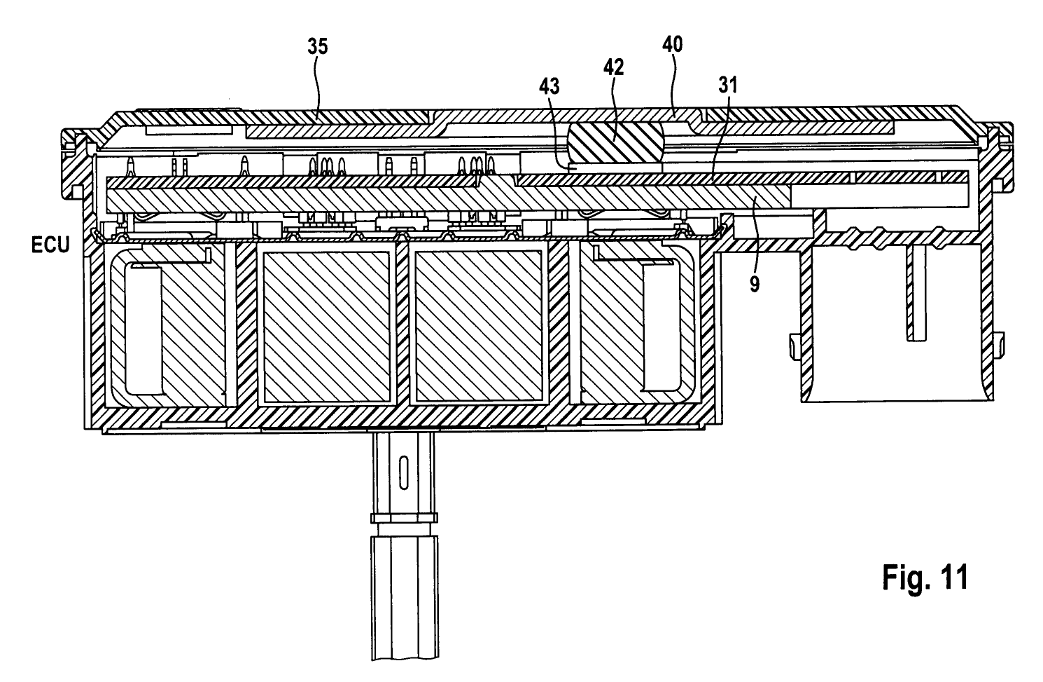

The ECU shown in FIG. 10 comprises in addition to heat-conducting plate 9 another heat-conducting plate III 40 which is connected to the plastic cover 8. The heat-conducting plate 40 is connected in a thermally conductive fashion to the heat-conducting plate 9 by way of heat-conducting spring 41 or by way of a heat-conducting cushion (reference numeral 42 in FIG. 11). On the side of the heat-conducting plate 9 close to the valve coils, spring steel sheets 45 contacting the coils are arranged in the area of the coils.

In the ECU according to FIG. 11, heat-conducting plate III 40 is led to the outside into a peripheral zone of cover 35 so that it is in direct thermal contact with the ambient air. This cooling measure is especially favorable because the additional cooling plate can beat ached to the cover 35 in a simple fashion by means of a glued joint. Further, there is a thermally conductive connection from the inside surface of plate 40 via heat-conducting cushions 42 to the printed circuit board 31, to the additional heat-conducting plate 9 or directly to the surface of an electronic component 43 being cooled, such as the integrated power electronics of the ECU. Heat-conducting cushions 42 can deform plastically and/or elastically.

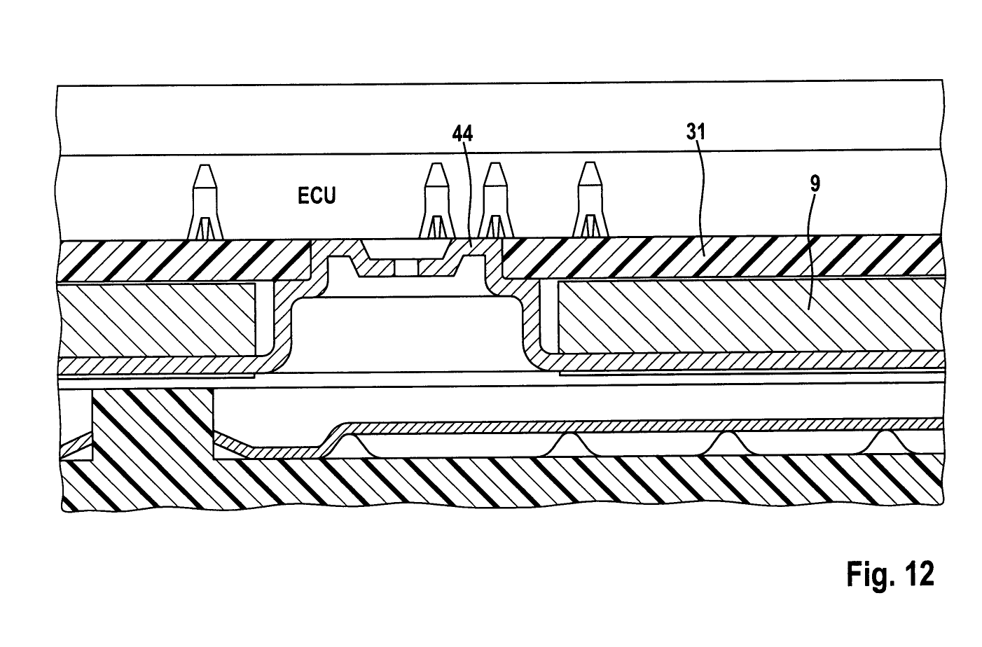

In FIG. 12, a heat-conducting plate 31 of aluminum is connected to heat-conducting plate 9 by a copper metal sheet 44, which is expediently connected by gluing with aluminum plate 31 and pressed into printed circuit board 9. This achieves improved dissipation of the heat from the printed circuit board to the heat-conducting plate. Compared to an alternatively usable copper rivet, the heat dissipation of the illustrated copper metal sheet 44 press fitted into the heat-conducting plate is enhanced.

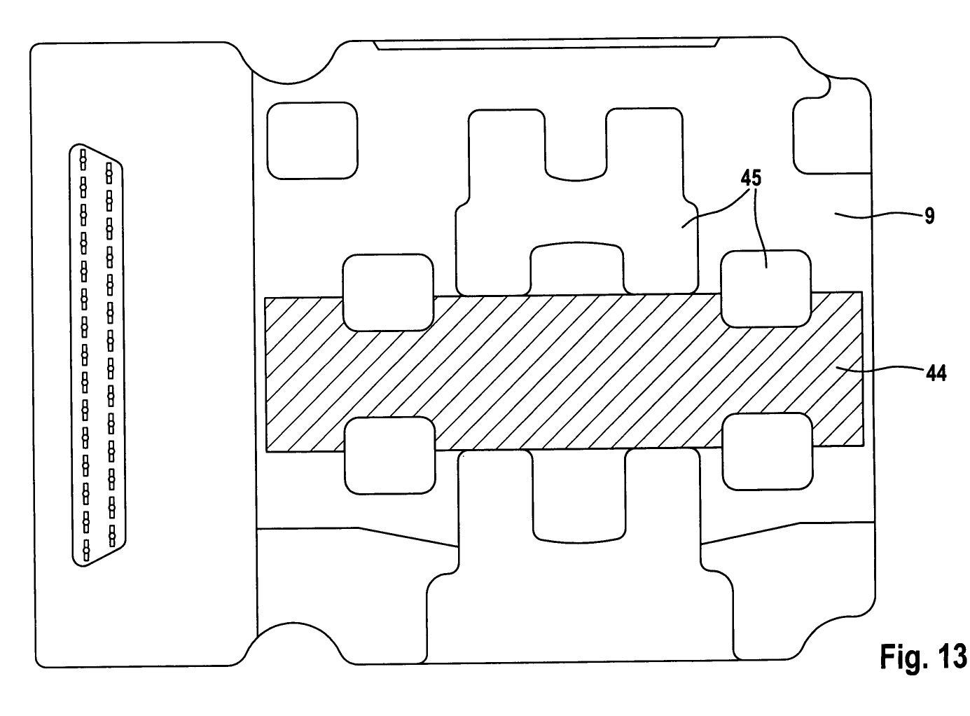

FIG. 13 shows how the said copper metal sheet 44 is positioned on part of the surface of heat-conducting plate 9. The glued surface is dimensioned such that it lies within the spring elements 45 (cf. FIG. 10).

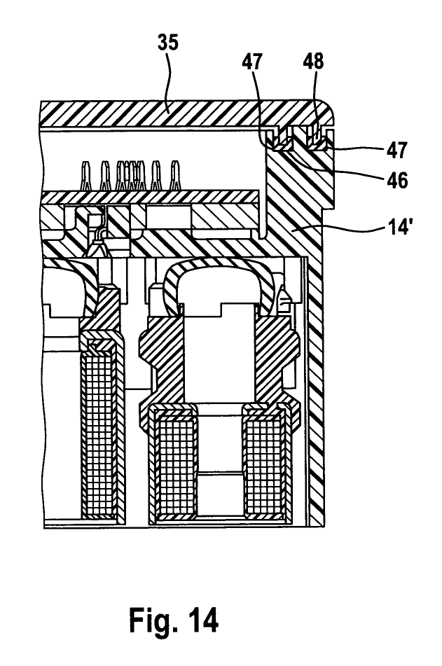

FIG. 14 represents a connecting zone between metal cover 35 and housing wall 14′. A friction-welding contour 46, which extends at the edge of the cover, establishes a molecular bond between cover 35 and housing wall 14′. Contour 46 is like a trough and can be filled with adhesive 49 or any sealing material. Web 48 engages chambers 47 in a molecular bond or in a sealed fashion. The use of two chambers 47 not only achieves a particularly tight connection and seal-tightness, but also provides a possibility of using the housing 14 universally both for closing with a metal cover and with a plastic cover. In this arrangement, a cover being configured separately of the controller housing is advantageous because the retroactive installation of additional boards for additional functions becomes easily feasible in the sense of a modular concept (see additional board at the cover in FIG. 10).

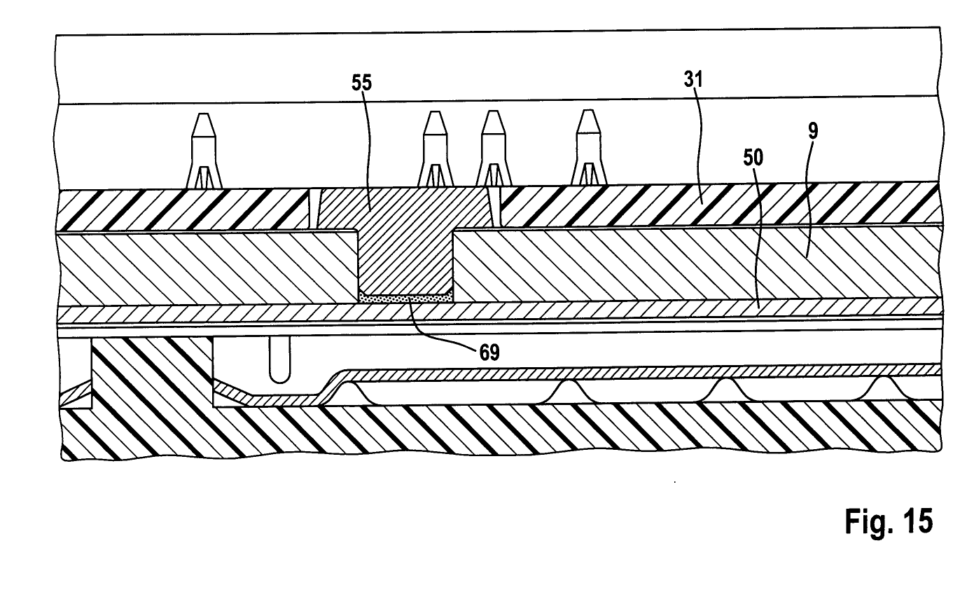

Similar to FIG. 12, FIG. 15 shows the thermal coupling between printed circuit board 31 and heat-conducting plate 9. In the example shown herein, thermal coupling between the plates 31 and 9 is constituted by copper rivet 55, with rivet 55 being molecularly interfaced with copper plate 50. The attachment at plate 50 is expediently done by means of a thin adhesive layer 69. Copper plate 50 also is molecularly interfaced with heat-conducting plate 9.

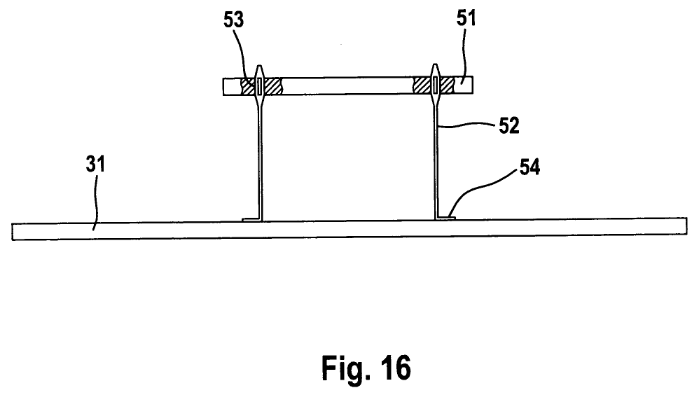

FIG. 16 shows schematically a possibility of mechanically and electrically connecting a small additional printed circuit board 51 (baby board) which carries additional, possibly optional electronic components, with a printed circuit board 31 in the ECU. Contact pins 52 are connected to the corresponding printed circuit board 31 by way of a press-in contact 53 at one end and by way of a SMD contact 54 at the other end.

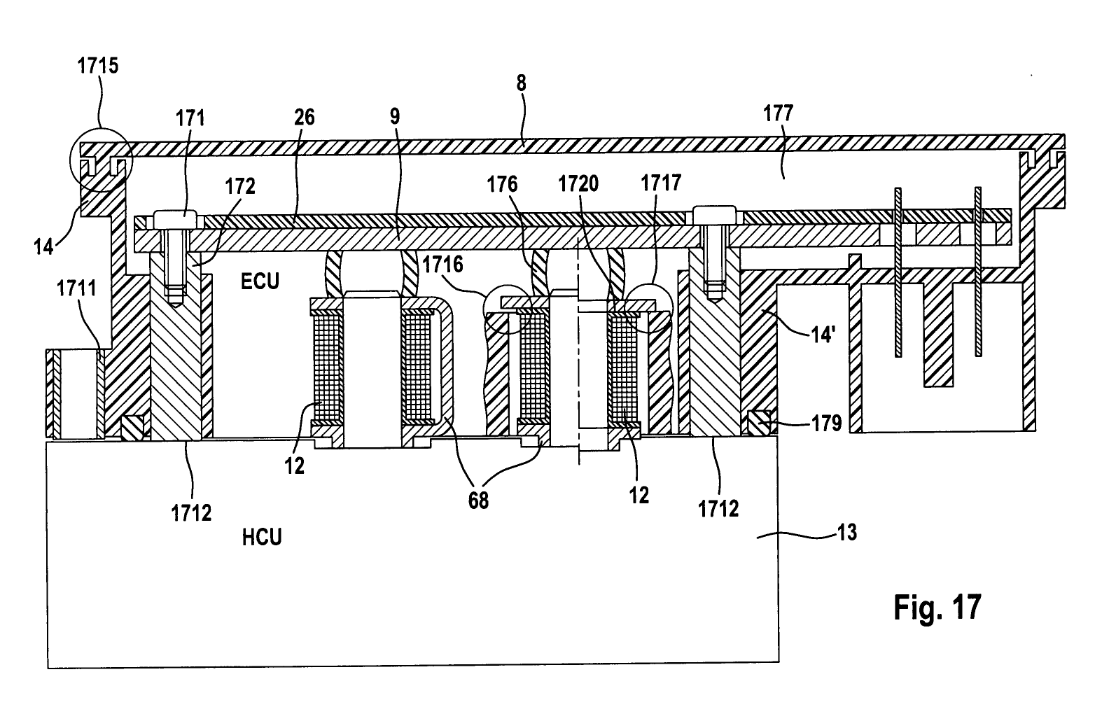

In FIG. 17, a controller housing 14 made of plastics by injection-molding is screwed to valve block 13. Metal members 172 are embedded in controller housing 14 and connected by means of screws 171 to the unit being formed of printed circuit board 26 and cooling plate 9. In the mounted condition, they abut with their end faces directly on valve block 13. Printed circuit board 26 is glued or laminated to metal plate 4 for cooling purposes. The so formed subassembly is fixed in the housing 14 by positioning and attaching the metal plate 9 on the end surfaces of the metal members 172 that are remote from the valve block. Magnet coils 12 are supported via elastomeric rings 176 elastically towards the fixed metal plate 9 in this example and are thus urged with their metallic yokes 68 against the surface of the valve block 13. Wall 14′ of controller housing 14 forms electronics chamber 177, which is sealed towards the atmosphere by means of circumferential seal 179 to valve block 13. Towards the top, chamber 177 is closed by cover 8, which is fastened to wall 14′ by means of friction-welding (see zone 1715). The abutment surfaces of the metal members 172, which bear against valve block 13, are disposed within the sealed zone. ECU housing 14 is connected to valve block 13 using screws (not shown) by means of metallic sleeves 1711 embedded in the controller housing 14. To ensure a reliable abutment of the metal members 172 on the valve block 13, a minimal residual gap is provided in the unloaded condition between the front end of the sleeves 1711 and the surface for the valve block 13, which gap is closed by elastic deformation of the housing 14 when the fastening screws (not shown) are tightened.

Prior to the assembly of the controller housing 14 to valve block 13, magnet coils 12 are urged by elastomeric rings 176 with abutment surfaces 1720) machined in yoke metal sheets 68 (see area 1717) against the honeycombed partitions of the housing 14 being downwards open, and are thereby fixed axially in position. During the assembly of valve block 13, the stop shoulders are lifted from the partitions of housing 14 (see zone 1716) when the frontal ends of the yokes 68 are placed on valve block 13.

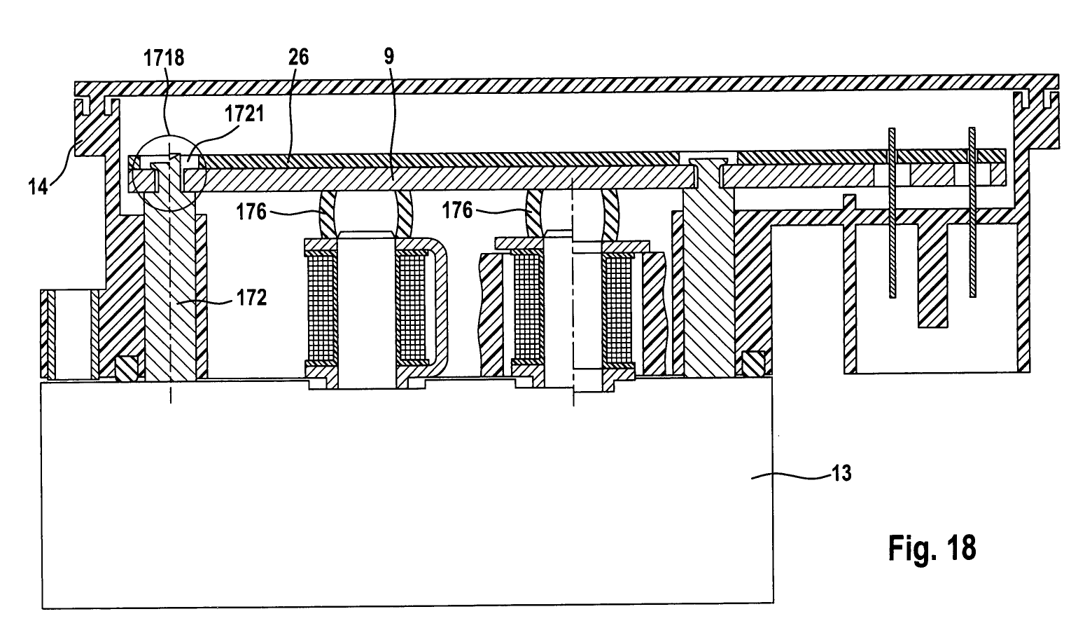

The controller housing 14 illustrated in FIG. 18 largely corresponds to the controller housing in FIG. 18, with the exception of the fixation of the metal plate 9. In this example, the heat-conducting metal members 172 are connected to metal plate 9 by way of a wedged joint 1718 of a portion of the metal member 172 provided for this purpose. An appropriate recess 1721 is arranged in the printed circuit board 26 in the area of the wedged joint to be achieved.

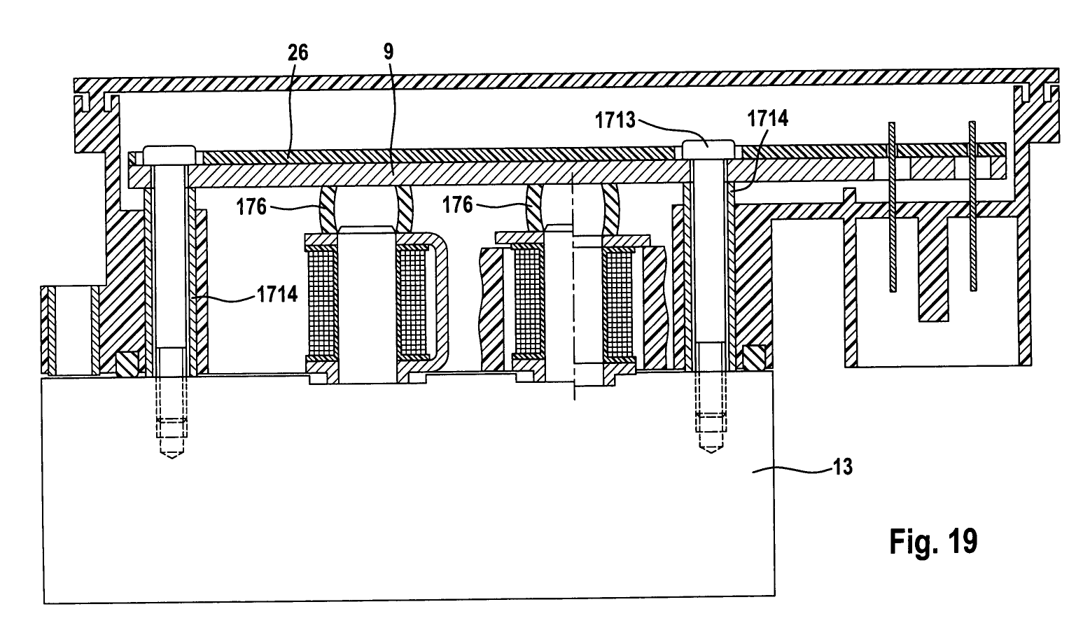

In contrast to the examples in FIGS. 17 and 18, the heat-conducting metal members are configured as sleeves 1714 in FIG. 19. Sleeves 1714 can be used additionally in an especially advantageous manner by way of screws 1713 to attach the controller housing 14 to valve block 13. In this case, printed circuit board 26, cooling plate 9, and controller housing 14 are fixed with screws 1713 to hydraulic block 13, before cover 8 can be mounted on housing 14. An independent assembly of HCU and ECU is not possible in this case.

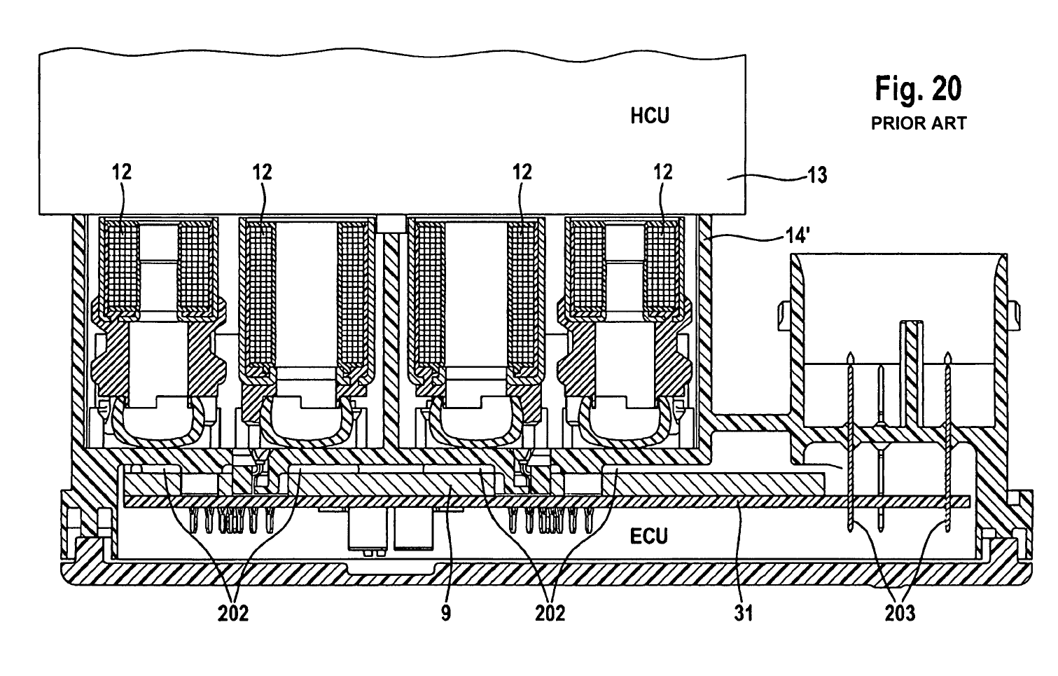

FIG. 20 shows a controller housing 14 (ECU) that is already connected to the HCU for the accommodation of the valve coils 12 and the electronics according to the prior art. Printed circuit board 31 is connected to an aluminum plate 9 used for cooling by way of a lamination process. The arrangement of printed circuit board and cooling plate is invariably fixed by way of press-in connections 203 of the plug contacts and by means of several cementing operations 202. A direct metallic connection between the cooling plate 9 serving as a heat sink and valve block 13 does not exist.

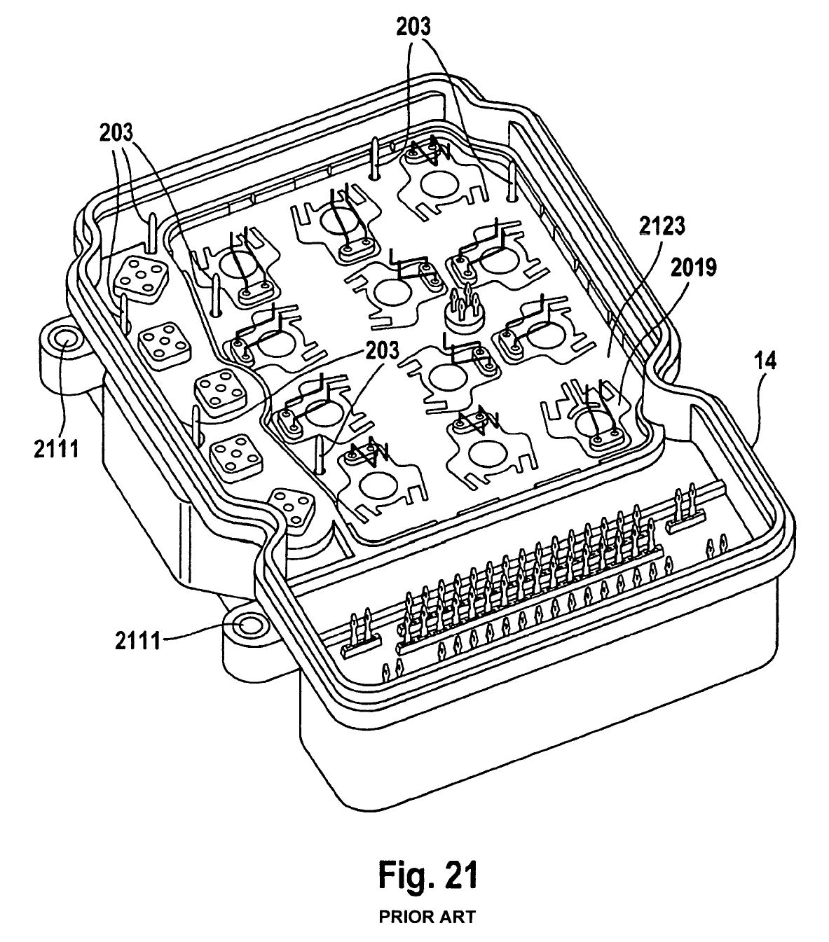

In a controller housing 14 according to FIG. 21, which is likewise known already, the printed circuit board (not shown) is connected to the controller housing also by way of press-in contacts 203. Housing 14 is screwed to valve block 13 also by means of screws slipped through sleeves 2111. A direct metallic connection between the aluminum plate (not shown) and valve block (not shown) likewise does not exist. In order to achieve an axial fixation of the magnet coils 2019, a resilient metal sheet 2123 with a complex geometry is press fitted into the controller housing 14 in addition.

### LIST OF REFERENCE NUMERALS

1 valve block sealing
2 welded cover with mounting frame for aluminum heat-conducting plate
3 hot wedged or soldered wire of the valve coil
4 aluminum heat-conducting members which are cast into the aluminum heat-conducting plate
5 component carrier plate (PCB) to be equipped on both sides for attachment of coils and pressure sensors
6 valve coil with a low resistance
7 coil housing having the shape of a honecomb without bottom
8 housing cover
9 heat-conducting plate I
10 press-in contacts
11 connecting plug for control device
12 valve coil
13 hydraulic unit (HCU, valve block)
14 electronic control unit housing (ECU)
14′ controller housing wall
15 connector of printed circuit board planes
16 injection-molded press-in contacts
17 strip conductor carrier for motor control
18 pump-driving unit
20 injection-molded seal
21 tolerance-compensating heat-conducting element
22 base plate made of plastics
23 motor brushes
24 brush contact
25 contact plug (female) for line passage from ECU to pump-driving unit with crimped connection
26 printed circuit board (PCB)
27 motor axle
28 welding contacts
29 connecting wires
30 rod-shaped connection to the pump-driving unit
31 printed circuit board (PCB)
32 heat-conducting plate II
34 abutment surface
34′ abutment surface
35 metal cover
36 additional board
37 pressed screen
38 nut or rivet
39 bolt
40 heat-conducting plate III
41 heat-conducting spring
42 heat-conducting cushion
43 integrated power electronics
44 copper metal sheet
45 spring steel sheet
46 friction-welding contour
47 chambers
48 web
49 adhesive
50 copper plate
51 additional printed circuit board
52 contact element
53 press-in contact
54 SMD contact
55 copper rivet
56 fixation pins
57 holding web
58 groove
59 flexible foil
60 metal pin
61 rivet connection
62 wedged connection
63 abutment surface
64 double press-in contact
65 coil contacts
66 copper pin
67 resilient coil suspension
68 coil yoke
69 adhesive layer
70 clamping tongue
171 screw
172 metallic heat-conducting elements
176 elastomeric ring
177 electronics chamber
179 seal
1711 metal sleeves
1712 abutment surface
1713 screw
1714 sleeve
1715 closure zone of the cover
1716 zone
1717 zone
1718 wedged joint
1720 abutment surface
1721 recess
202 adhesive layer
203 press-in contact connections
2019 magnet coils
2111 sleeves
2123 metal sheet

1-29. (canceled)

30. An electronic control unit (14) connected to a hydraulic unit (13) via a magnetic plug, in a motor vehicle brake system, comprising:
a zone formed of housing walls (14′) for accommodating two or more valve coils (12) arranged in the zone;
a housing cover (8, 35);
at least one first printed circuit board (31, 5) for accommodating of electronic components and an electrical contact; and
a first heat-conducting plate (9, 32) for dissipating of heat of the electronic components, wherein the first heat-conducting plate is planarly connected to the first printed circuit board, and at least one thermal connecting element (4, 15) is provided, which constitutes a thermal bridge between the first printed circuit board(s) and the first heat-conducting plate(s).

31. An electronic control unit according to claim 30, wherein at least one valve coil of the two or more valve coils is connected to an additional printed circuit board (5) or an additional heat-conducting plate (32).

32. An electronic control unit according to claim 31, wherein thermal connecting elements (4, 15) are used to provide an electrical connection between the first printed circuit board and the additional printed circuit board.

33. An electronic control unit according to claim 31, wherein at least one valve coil of the two or more valve coils is mechanically elastically attached to the additional heat-conducting plate.

34. An electronic control unit according to claim 31, wherein the additional printed circuit board (5) is used for electrical connection of the two or more valve coils.

35. An electronic control unit according to claim 30, wherein at least one of the two or more valve coils is connected mechanically to the first heat-conducting plate (9).

36. An electronic control unit according to claim 30, wherein the first heat-conducting plate is welded to at least one of the cover and the housing (14).

37. An electronic control unit according to claim 30, wherein the coil housings have a honeycomb structure.

38. An electronic control unit according to claim 30, wherein the controller housing is connected to a hydraulic valve block (13), and the controller wall (14′) is sealed by means of a circumferential groove (58) provided in the valve block, in particular with at least two chambers (47), and a molecular bond is established by way of the groove after joining of the electronic control unit and the valve block.

39. An electronic control unit according to claim 30, wherein the cover (8) has recesses through which a metal part used for cooling exits to the outside.

40. An electronic control unit according to claim 30, wherein the cover (35) is made of metal.

41. An electronic control unit according to claim 30, wherein metal pins (66) are employed for cooling integrated electronic power components, which are thermally connected to the heat-conducting plate.

42. An electronic control unit according to claim 30, wherein additional boards (36) are provided, which are electrically connected to the first printed circuit board.

43. An electronic control unit according to claim 30, wherein a pressed frame is provided, which is mounted to contact the coils, with the pressed frame being mechanically connected to the housing in a tight manner, and with the pressed frame including press-in contact pins which establish an electrical connection with the printed circuit board, while the coils are elastically held.

44. An electronic control unit according to claim 30, wherein a pressed screen (37) is provided, which is mounted to contact the coils, with the pressed screen being mechanically connected to the housing in a tight manner, and with the pressed screen including press-in contact pins which establish an electrical connection with the printed circuit board, while the coils are elastically held.

45. An electronic control unit according to claim 30, wherein an additional heat-conducting plate is connected in molecular bond, operatively or positively to the cover (8, 35), which latter is thermally connected to at least one of the first printed circuit board and the first heat-conducting plate (9) by way of a heat contact element (41, 42).

46. An electronic control unit according to claim 30, wherein an aluminum plate (31) which ensures thermal connection of the heat-conducting plate is cemented to the first heat-conducting plate (9).

47. An electronic control unit according to claim 30, wherein the cover (35) is attached to the housing wall (14′) by way of a molecular bond which comprises two troughs (47).

48. An electronic control unit according to claim 30, wherein an additional board (51) is electrically and mechanically connected to the frist printed circuit board by at least one contact element (52), with the at least one contact element being connected by a press-in contact (53) on one side and by a SMD contact (54) on the other side.

49. A pump driving unit for an electronic control unit which is connected a hydraulic unit (HCU), the pump driving unit comprising:
an electric motor driving a driving axle; and
a motor base plate (22) accommodating electronic power components of the motor, wherein the motor base plate is in thermal contact with the hydraulic block (HCU) via a deformable heat-conducting element (21), and the hydraulic block comprises a zone formed of housing walls (14′) for accommodating two or more valve coils (12) arranged in the zone;
a housing cover (8, 35);
at least one first printed circuit board (31, 5) for accommodating of electronic components and an electrical contact; and
a first heat-conducting plate (9, 32) for dissipating of heat of the electronic components.

50. A pump driving unit according to claim 49, wherein a rod-shaped motor plug is adapted to be plugged into the motor base plate or into a bushing (25) arranged thereon in order to provide an electrically conductive connection.

51. A method of manufacturing an electronic control unit comprising:
providing a frame made up of housing walls (14′) that defines a coil accommodation zone;
inserting a printed circuit board assembly (31, 9, 3) in a zone predetermined by the frame, and elements (56) are provided to fix the printed circuit plate assembly to the frame; and
mounting a cover (8) onto the printed circuit board assembly, wherein the cover comprises holding elements (57) which fix the printed circuit board assembly when the cover is mounted.

52. A method according to claim 51, wherein the cover is connected to the housing using a friction welding method.

53. An electrohydraulic control device comprising:
a mounting frame for mounting one or more electric valve coils (12) thereon, wherein the mounting from is substantially made of plastics;
a strip conductor carrier having at least one semiconductor element producing thermal energy and at least one planar cooling element (9);
a hydraulic block connected to the mounting frame and having valve domes of magnetically drivable hydraulic valves that project from a surface of the hydraulic block, wherein the hydraulic valves being arranged inside the hydraulic block; and
one or more elongated heat-conducting element (172) is provided in contact with the hydraulic block (13) and to the cooling element (9) to form a thermal bridge so that a heat flow is enabled between hydraulic block and cooling element, wherein a longitudinal side of the one or more heat-conducting element (172) is operatively or positively connected to the hydraulic block or the cooling element (9), and an opposed longitudinal side (1712) bear against the hydraulic block or the cooling element without the operative connection in a detachable manner.

54. An electrohydraulic control device according to claim 53, wherein the mounting frame is operatively connected to the hydraulic block and the cooling element using a bolt that extends through the heat-conducting element or a screw (1713).

55. An electrohydraulic control device according to claim 53, wherein displaceable valve coils (12) encompassed by the mounting frame are provided, which enclose the valve domes and are displaceable in an axial direction, i.e. in a direction of the longitudinal axes of the valve domes, and elastomeric members (176) are disposed in an area between an abutment surface of the mounting frame for the valve coils, the elastomeric members are compressed by axial displacement of the valve coils when the mounting frame and the hydraulic block are joined, and planar holding elements are provided between the elastomeric members and the valve coils being so configured that, in the condition not compressed by the valve coils, drop-out of the coils from the mounting frame is prevented by an abutment surface (1720), with the planar holding elements bearing against the abutment surfaces only in the mentioned uncompressed condition.

56. An electrohydraulic control device according to claim 53, wherein a friction-welded cover (8) closes the accommodation of the electronics of the controller (14).

57. An electrohydraulic control device according to claim 53, wherein the one or more elongated heat-conducting elements is attached to the planar cooling element by a wedging operation.
